(19) United States
(12) Patent Application Publication
(10) Pub. No.: US 2025/0004142 A1
(43) Pub. Date: Jan. 2, 2025

(54) GLOBAL NAVIGATION SATELLITE SYSTEMS (GNSS) LOCALIZATION WITH RESIDUAL GRID REPRESENTATION

(71) Applicant: QUALCOMM Incorporated, San Diego, CA (US)

(72) Inventors: Davide BELLI, Diemen (NL); Bence MAJOR, Amsterdam (NL); Amir JALALIRAD, Amsterdam (NL); Songwon JEE, San Jose, CA (US); Himanshu SHAH, Milpitas, CA (US); William MORRISON, San Francisco, CA (US)

(21) Appl. No.: 18/630,717

(22) Filed: Apr. 9, 2024

Related U.S. Application Data
(60) Provisional application No. 63/510,789, filed on Jun. 28, 2023.

(51) Int. Cl. G01S 19/42; G01S 19/39; G01S 19/40; G06N 3/0464

(52) U.S. Cl. CPC G01S 19/42; G01S 19/396; G01S 19/40; G06N 3/0464

(57) ABSTRACT

In some implementations, a global navigation satellite system (GNSS) device may determine its approximate location, and, for each pseudorange measurement of a plurality of pseudorange measurements performed by the GNSS device: determine a location of a respective satellite vehicle (SV) that transmits a respective GNSS signal of which the pseudorange measurement is performed, and determine a respective residual grid, where the respective residual grid is based on respective information from the pseudorange measurement and the location of the respective SV, and the respective residual grid is indicative of possible locations of the GNSS device within a geographical region including the approximate location of the GNSS device. The GNSS device may aggregate the residual grids corresponding to at least a portion of the plurality of pseudorange measurements and may determine a location estimate of the GNSS device based on the aggregation of the residual grids.

### RELATED APPLICATIONS

This application claims the benefit of U.S. Provisional Application No. 63/510,789, filed Jun. 28, 2023, entitled “GLOBAL NAVIGATION SATELLITE SYSTEMS (GNSS) LOCALIZATION WITH RESIDUAL GRID REPRESENTATION”, which is assigned to the assignee hereof, and incorporated herein in its entirety by reference.

### BACKGROUND

The present disclosure relates generally to the field of positioning, and in particular, global navigation satellite system (GNSS) positioning.

Modern electronic devices frequently include systems that can receive signals from satellite navigation systems, commonly referred to as GNSS, and use those signals to determine the location of the device, as well as other information such as speed, heading, altitude, etc. Such GNSS receivers may be integrated into consumer electronic devices, such as smartphones or smartwatches, as well as into navigation systems in different types of vehicles, including cars, trucks, ships, and aircraft. Signals are received by a GNSS receiver from multiple satellites orbiting the Earth and processed to estimate or predict the location of the GNSS receiver. “First fix” positioning (as opposed to “continuous tracking”) involves the positioning of a GNSS receiver without prior knowledge of where the receiver is and can take a particularly long time to determine in view of non-line of sight (NLOS) signals, multipath, and/or other issues.

### BRIEF SUMMARY

An example method of positioning a global navigation satellite system (GNSS) device using residual grid representation, according to this disclosure, may comprise determining an approximate location of the GNSS device. The method also may comprise, for each pseudorange measurement of a plurality of pseudorange measurements performed by the GNSS device: determining a location of a respective satellite vehicle (SV) that transmits a respective GNSS signal of which the pseudorange measurement is performed, the location of the respective SV relative to the approximate location of the GNSS device. The method also may comprise determining a respective residual grid, wherein: the respective residual grid is based at least in part on respective information from the pseudorange measurement and the location of the respective SV, and the respective residual grid is indicative of possible locations of the GNSS device within a geographical region including the approximate location of the GNSS device. The method also may comprise aggregating the residual grids corresponding to at least a portion of the plurality of pseudorange measurements. The method also may comprise determining a location estimate of the GNSS device based at least in part on the aggregation of the residual grids.

An example method of positioning a global navigation satellite system (GNSS) device using residual grid representation, according to this disclosure, may comprise determining an approximate location of the GNSS device. The method also may comprise, for each pseudorange measurement of a plurality of pseudorange measurements performed by the GNSS device, determining respective residual information, wherein the respective residual information is based at least in part on respective information from the pseudorange measurement and the location of the respective SV. The method also may comprise aggregating the residual information corresponding to at least a portion of the plurality of pseudorange measurements, wherein the aggregating comprises: creating a graph representative of relationships between pairs of pseudorange measurements of at least a subset of the plurality of pseudorange measurements, processing the at least a subset of the plurality of pseudorange measurements with a graph neural network (GNN), and pooling outputs of the GNN from the processing. The method also may comprise determining a location estimate of the GNSS device based at least in part on the aggregation of the residual information.

An example global navigation satellite system (GNSS) device comprising: a GNSS receiver, a memory, one or more processors communicatively coupled with the GNSS receiver and the memory, wherein the one or more processors are configured to determine an approximate location of the GNSS device. The one or more processors further may be configured to, for each pseudorange measurement of a plurality of pseudorange measurements performed by the GNSS device using the GNSS receiver: determine a location of a respective satellite vehicle (SV) that transmits a respective GNSS signal of which the pseudorange measurement is performed, the location of the respective SV relative to the approximate location of the GNSS device. The one or more processors further may be configured to determine a respective residual grid, wherein: the respective residual grid is based at least in part on respective information from the pseudorange measurement and the location of the respective SV, and the respective residual grid is indicative of possible locations of the GNSS device within a geographical region including the approximate location of the GNSS device. The one or more processors further may be configured to aggregate the residual grids corresponding to at least a portion of the plurality of pseudorange measurements. The one or more processors further may be configured to determine a location estimate of the GNSS device based at least in part on the aggregation of the residual grids.

An example global navigation satellite system (GNSS) device comprising: a GNSS receiver, a memory, one or more processors communicatively coupled with the GNSS receiver and the memory, wherein the one or more processors are configured to determine an approximate location of the GNSS device. The one or more processors further may be configured to, for each pseudorange measurement of a plurality of pseudorange measurements performed by the GNSS device using the GNSS receiver, determine respective residual information, wherein the respective residual information is based at least in part on respective information from the pseudorange measurement and the location of the respective SV. The one or more processors further may be configured to aggregate the residual information corresponding to at least a portion of the plurality of pseudorange measurements, wherein the aggregating comprises: create a graph representative of relationships between pairs of pseudorange measurements of at least a subset of the plurality of pseudorange measurements, process the at least a subset of the plurality of pseudorange measurements with a graph neural network (GNN), and pooling outputs of the GNN from the processing. The one or more processors further may be configured to determine a location estimate of the GNSS device based at least in part on the aggregation of the residual information.

An example apparatus for positioning a global navigation satellite system (GNSS) device using residual grid representation, according to this disclosure, may comprise means for determining an approximate location of the GNSS device. The apparatus further may comprise for each pseudorange measurement of a plurality of pseudorange measurements performed by the GNSS device: means for determining a location of a respective satellite vehicle (SV) that transmits a respective GNSS signal of which the pseudorange measurement is performed, the location of the respective SV relative to the approximate location of the GNSS device. The apparatus further may comprise means for determining a respective residual grid, wherein: the respective residual grid is based at least in part on respective information from the pseudorange measurement and the location of the respective SV, and the respective residual grid is indicative of possible locations of the GNSS device within a geographical region including the approximate location of the GNSS device. The apparatus further may comprise means for aggregating the residual grids corresponding to at least a portion of the plurality of pseudorange measurements. The apparatus further may comprise means for determining a location estimate of the GNSS device based at least in part on the aggregation of the residual grids.

An example apparatus for positioning a global navigation satellite system (GNSS) device using residual grid representation, according to this disclosure, may comprise means for determining an approximate location of the GNSS device. The apparatus further may comprise for each pseudorange measurement of a plurality of pseudorange measurements performed by the GNSS device, determining respective residual information, wherein the respective residual information is based at least in part on respective information from the pseudorange measurement and the location of the respective SV. The apparatus further may comprise means for aggregating the residual information corresponding to at least a portion of the plurality of pseudorange measurements, wherein the aggregating comprises: means for creating a graph representative of relationships between pairs of pseudorange measurements of at least a subset of the plurality of pseudorange measurements, means for processing the at least a subset of the plurality of pseudorange measurements with a graph neural network (GNN), and pooling outputs of the GNN from the processing. The apparatus further may comprise means for determining a location estimate of the GNSS device based at least in part on the aggregation of the residual information.

According to this disclosure, an example non-transitory computer-readable medium stores instructions for positioning a global navigation satellite system (GNSS) device using residual grid representation, the instructions comprising code for determining an approximate location of the GNSS device. The instructions further may comprise code for, for each pseudorange measurement of a plurality of pseudorange measurements performed by the GNSS device: determining a location of a respective satellite vehicle (SV) that transmits a respective GNSS signal of which the pseudorange measurement is performed, the location of the respective SV relative to the approximate location of the GNSS device. The instructions further may comprise code for determining a respective residual grid, wherein: the respective residual grid is based at least in part on respective information from the pseudorange measurement and the location of the respective SV, and the respective residual grid is indicative of possible locations of the GNSS device within a geographical region including the approximate location of the GNSS device. The instructions further may comprise code for aggregating the residual grids corresponding to at least a portion of the plurality of pseudorange measurements. The instructions further may comprise code for determining a location estimate of the GNSS device based at least in part on the aggregation of the residual grids.

According to this disclosure, an example non-transitory computer-readable medium stores instructions for positioning a global navigation satellite system (GNSS) device using residual grid representation, the instructions comprising code for determining an approximate location of the GNSS device. The instructions further may comprise code for, for each pseudorange measurement of a plurality of pseudorange measurements performed by the GNSS device, determining respective residual information, wherein the respective residual information is based at least in part on respective information from the pseudorange measurement and the location of the respective SV. The instructions further may comprise code for aggregating the residual information corresponding to at least a portion of the plurality of pseudorange measurements, wherein the aggregating comprises: creating a graph representative of relationships between pairs of pseudorange measurements of at least a subset of the plurality of pseudorange measurements, processing the at least a subset of the plurality of pseudorange measurements with a graph neural network (GNN), and pooling outputs of the GNN from the processing. The instructions further may comprise code for determining a location estimate of the GNSS device based at least in part on the aggregation of the residual information.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified diagram of a global navigation satellite system (GNSS) system, according to an embodiment.

FIG. 2 is a diagram that depicts an example situation in which GNSS signals are used to determine an improved position of a mobile device.

FIG. 3 is an example multi-modal location distribution graph, according to an embodiment.

FIG. 4 is an illustration of aspects of how residual grid representation may be made, according to an embodiment.

FIGS. 5A and 5B illustrate residual grids showing aspects of residual grid creation for a pseudorange measurement, according to an embodiment.

FIG. 6 is a graph indicating the timing of when measurements are made by a GNSS receiver of incoming signals, according to an example.

FIGS. 7A-7C illustrate processes by which residual grids may be used for GNSS positioning, according to some embodiments.

FIG. 8 is an illustration of an embodiment for providing end-to-end GNSS positioning with residual grids, according to an embodiment.

FIGS. 9A-9C illustrate examples of different graph types that may be used by a graph neural network (GNN) for GNSS-based positioning, according to some embodiments.

FIG. 10 illustrates how a GNN may be used in an end-to-end GNSS positioning method, according to an embodiment.

FIG. 11 illustrates how the process in FIG. 10 may be modified to use a global feature array, according to an embodiment.

FIG. 12 is a flow diagram of a method of positioning a GNSS receiver using residual grid representation, according to an embodiment.

FIG. 13 is a block diagram of an embodiment of a GNSS device.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples will now be described with respect to the accompanying drawings, which form a part hereof. While particular examples, in which one or more aspects of the disclosure may be implemented, are described below, other examples may be used, and various modifications may be made without departing from the scope of the disclosure or the spirit of the appended claims.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples.

As used herein, a radio frequency (RF) signal comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

Further, unless otherwise specified, the term “positioning” and/or “localization” as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

Certain aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets that may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to perform denoising of RF sensing data. Thus, during the operation of a device, the ML model may receive input data (such as a range-Doppler image (RDI), reference noise variance, reference signal-to-noise ratio (SNR), number of targets, channel condition, etc.) and make inferences (such as object detection with reduced noise) based on the weights and biases.

ML models may be deployed in one or more devices (for example, network entities, user equipments (UEs), GNSS receivers, mobile devices, etc.) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as RF sensing, signal coding/decoding, network routing, energy conservation, etc.

According to an example, a device and/or system may estimate its location based, at least in part, on signals received from space vehicles (SVs) (e.g., satellites). In particular, such a device and/or system may obtain pseudorange measurements comprising approximations of distances between associated SVs and a navigation satellite receiver. In a particular example, such a pseudorange may be determined at a receiver that is capable of processing signals from one or more SVs as part of a GNSS (which may also be referred to as a Satellite Positioning System (SPS)). Examples of GNSS systems include Global Positioning System (GPS), established by the United States; Globalnaya Navigatsionnay Sputnikovaya Sistema, or Global Orbiting Navigation Satellite System (GLONASS), established by the Russian Federation and similar in concept to GPS; the BeiDou Navigation Satellite System (BDS) created by the Chinese; and Galileo, also similar to GPS but created by the European Community and slated for full operational capacity in the near future. To determine its position, a satellite navigation receiver may obtain pseudorange measurements to four or more satellites as well as their positions at time of transmitting. Knowing the SVs' orbital parameters, these positions can be calculated for any point in time. A pseudorange measurement may then be determined based, at least in part, on the time a signal travels from an SV to the receiver, multiplied by the speed of light. While techniques described herein may be provided as implementations of location determination in a GPS and/or Galileo types of GNSS systems as specific illustrations according to particular examples, it should be understood that these techniques may also apply to other types of GNSS systems, and that claimed subject matter is not limited in this respect.

A GNSS as referred to herein relates to a navigation system comprising SVs transmitting synchronized navigation signals according to a common signaling format. Such a GNSS may comprise, for example, a constellation of SVs in synchronized orbits to transmit navigation signals to locations on a vast portion of the Earth's surface simultaneously from multiple SVs in the constellation. An SV which is a member of a particular GNSS constellation typically transmits navigation signals in a format that is unique to the particular GNSS format. Accordingly, techniques for acquiring a navigation signal transmitted by an SV in a first GNSS may be altered for acquiring a navigation signal transmitted by an SV in a second GNSS. In a particular example, although claimed subject matter is not limited in this respect, it should be understood that GPS, Galileo, and GLONASS each represent a GNSS system that is distinct from the other two named GNSS systems. However, these are merely examples of GNSS systems, and claimed subject matter is not limited in this respect.

As previously noted, “first fix” GNSS positioning can take a relatively long time due to the lack of position history information for a GNSS receiver. This can be exacerbated by issues such as non-line-of-sight (NLOS) signals (e.g., signals that are received indirectly, after one or more reflections) and multipath (e.g., signals that are received multiple times, which may be due to reflections). Accordingly, determining a first fix in an urban environment, in which signals are very frequently reflected, can be particularly challenging. Traditional techniques involve using weighted least squares (WLS) fitting to minimize residuals from all measure distances to determine a most likely position, but this can take a relatively long time.

To address these and other issues, embodiments herein utilize grid representations of residuals from measurements taken by a GNSS receiver to quickly and efficiently perform GNSS positioning, these techniques can be particularly helpful for first-fix positioning. In particular, machine learning models can be utilized to process the grid representations of the residuals. The output of this processing may comprise residual corrections, which may be fed into a traditional WLS algorithm for GNSS receiver positioning. Additionally or alternatively, the output of this processing may involve providing an estimated position of the GNSS receiver and/or a position distribution of the GNSS receiver. Embodiments provided herein describe ways in which residual grid representations may be created and processed. Further, according to some embodiments, processing the residual grid representations may comprise formulating graphs representative of measurement features and relationships, and processing the graphs using a graph neural network (GNN).

Various aspects of this disclosure relate generally to the positioning of a GNSS receiver. As noted, some aspects more specifically relate to the processing of residuals of GNSS measurements for accurate position determination. In some examples, a residual grid may be created for each of the plurality of pseudorange measurements based on the location of the respective SV and respective information from the pseudorange measurement. Residual grids can then be processed and aggregated to provide an estimated location of the GNSS receiver and/or to provide information for further processing (e.g., by a traditional WLS algorithm). According to some aspects, residual grids may include modifications that take into account error correction (e.g., receiver clock bias, ionosphere/troposphere delay, etc.). According to some aspects, visual features of the residual grids may be identified by convolutional neural networks (CNNs) and may be combined with signal features. According to some aspects, the resulting features further may be represented as graphs and processed by GNNs. The output of processing may be aggregated and/or pooled. According to some embodiments, a multi-layer perceptron (MLP) may be used to process the aggregated/pooled information to output a predicted or estimated location of the GNSS receiver.

Particular aspects of the subject matter described in this disclosure can be implemented to realize one or more of the following potential advantages. In some examples, by representing residual information as grids, the described techniques can be used to enable neural networks (e.g., CNNs) to quickly and efficiently process residual information, ultimately resulting in efficient positioning of the GNSS receiver. As further detailed herein, techniques may be utilized to provide a position estimate of the GNSS receiver, and/or maybe “plugged-in” to existing solutions (e.g., WLS fitting) for providing the position estimate. Embodiments are described in detail after a brief review of applicable technology.

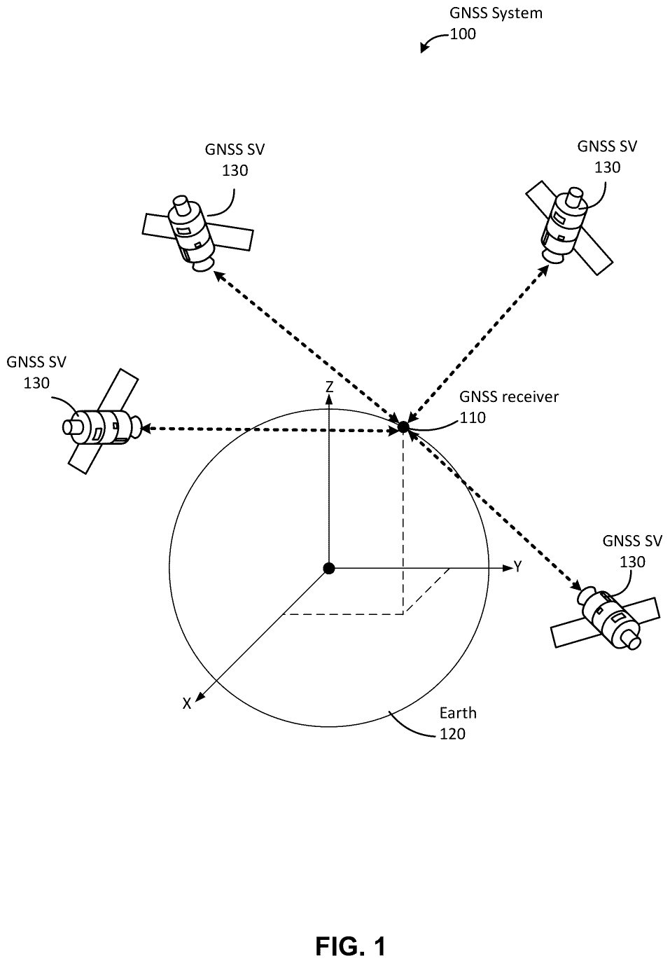

FIG. 1 is a simplified diagram of a GNSS system 100, provided to illustrate how GNSS is generally used to determine an accurate location of a GNSS receiver 110 on Earth 120. A GNSS receiver 110 may be incorporated into a mobile device or another device (e.g., vehicle, survey equipment, etc.), and, in some cases, GNSS positioning may be one of a plurality of positioning techniques that may be employed to determine the location of the mobile device. Put generally, the GNSS system 100 enables an accurate GNSS position fix of the GNSS receiver 110, which receives radio RF signals from GNSS SVs 130 from one or more GNSS constellations.

It will be understood that the diagram provided in FIG. 1 is greatly simplified. In practice, there may be dozens of SVs 130 and a given GNSS constellation, and there are many different types of GNSS systems. As noted, GNSS systems include, for example, GPS, Galileo, GLONASS, and BDS, as noted. Additionally, GNSS systems may include Quasi-Zenith Satellite System (QZSS) over Japan, Indian Regional Navigational Satellite System (IRNSS) over India, and/or the like. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on multilateration, which is a method of determining position by measuring distances to points at known coordinates. In general, the determination of the position of a GNSS receiver 110 in three dimensions may rely on a determination of the distance between the GNSS receiver 110 and four or more SVs 130. As illustrated, 3D coordinates may be based on a coordinate system (e.g., XYZ coordinates; latitude, longitude, and altitude; etc.) centered at the earth's center of mass. A distance between each SV 130 and the GNSS receiver 110 may be determined using precise measurements made by the GNSS receiver 110 of a difference in time from when a radio frequency RF signal is transmitted from the respective SV 130 and when it is received at the GNSS receiver 110. To help ensure accuracy, not only does the GNSS receiver 110 need to make an accurate determination of when the respective signal from each SV 130 is received, but many additional factors need to be considered and accounted for. These factors include, for example, clock differences at the GNSS receiver 110 and SV 130 (e.g., clock bias), a precise location of each SV 130 at the time of transmission (e.g., as determined by the broadcast ephemeris), the impact of atmospheric distortion (e.g., ionospheric and tropospheric delays), and the like.

As understood by those of ordinary skill in the art, triangulation may be used and may estimate a three-dimensional (3D) position. Triangulation may also estimate the clock difference between the device and the (all of the present) satellite system(s). A clock error may be different for each satellite system (GLONASS, GPS, Galileo, etc.). In summary, triangulation estimates three numbers representing 3D coordinates, and then one number for each satellite system, which represents the time difference between local time and the satellite system's time.

To perform a traditional GNSS position fix, the GNSS receiver 110 can use code-based positioning to determine its distance to each SV 130 based on a determined delay in a generated pseudorandom binary sequence received in the RF signals received from each satellite, in consideration of the additional factors and error sources previously noted. With the distance and location information of the SVs 130, the GNSS receiver 110 can then determine a position fix for its location. This position fix may be determined, for example, by a Standalone Positioning Engine (SPE) executed by one or more processors of the GNSS receiver 110. However, code-based positioning is relatively inaccurate and, without error correction, is subject to many of the previously described errors. Even so, code-based GNSS positioning can provide a positioning accuracy for the GNSS receiver 110 on the order of meters.

More accurate carrier-based ranging is based on a carrier wave of the RF signals from satellites and may use measurements at a base or reference station (not shown) to perform error correction to help reduce errors from the previously noted error sources. More specifically, errors (e.g., atmospheric errors sources) in the carrier-based ranging of SVs 130 observed by the GNSS receiver 110 can be mitigated or canceled based on similar carrier-based ranging of the SVs 130 using a highly accurate GNSS receiver at the base station at a known location. These measurements and the base station's location can be provided to the GNSS receiver 110 for error correction. This position fix may be determined, for example, by a Precise Positioning Engine (PPE) executed by one or more processors of the GNSS receiver 110. More specifically, in addition to the information provided to an SPE, the PPE may use base station GNSS measurement information, and additional correction information, such as precise orbit and clock, troposphere, and ionosphere, to provide a high-accuracy, carrier-based position fix. Several GNSS techniques can be adopted in PPE, such as Differential GNSS (DGNSS), Real-Time Kinematic (RTK), and Precise Point Positioning (PPP), and may provide a sub-meter accuracy (e.g., on the order of centimeters).

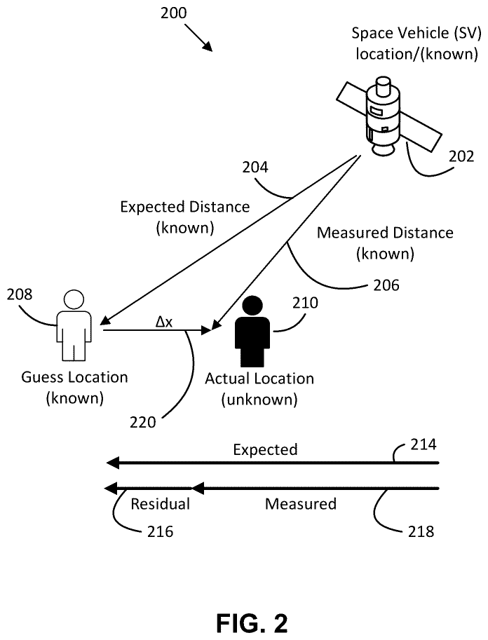

Aspects of GNSS positioning involved the reduction or minimization of residuals, which are errors or differences between an estimated location and the actual location of the GNSS receiver. Additional details are described hereafter with respect to FIG. 2.

FIG. 2 is a diagram of an example scenario 200 in which first-fix GNSS positioning is performed. In this scenario 200, a GNSS receiver measures GNSS signals transmitted by SV 202 (and other SVs, not shown) to determine its location. To help in the process, a guess or “seed” location 208, is used, which may be based on a non-GNSS source (e.g., a last known location, a known location of a detected wireless access point or cell tower, etc.). Because the guess location 208 is known and the SV location 202 is known, the expected distance 204 traveled by the GNSS signal transmitted by the SV 202 can be determined and is therefore known. Once the GNSS signal is measured by the GNSS receiver, a measured distance 206 can be determined, and a residual may result from the difference between the expected distance 204 and the measured distance 206.

Arrows 214-418 illustrate further illustrate how a residual is determined from a difference in expected distance 204 and measured distance 206. Here, expected distance arrow 214 (corresponding to expected distance 204) indicates the expected distance that would be measured at the guess location 208, measured distance arrow 218 indicates the distance that was actually measured by the GNSS receiver of the mobile device (e.g., at the actual location 210), and a residual arrow 216 indicates a difference between the expected distance arrow 214 and the measured distance arrow 218. By determining residuals for all GNSS measurements (e.g., of a plurality of SVS) taken by the GNSS receiver, the GNSS receiver can determine a correction, Δx 220, that may be applied to the guess location 208 to estimate the actual location 210.

Traditionally, measured distances to the satellites may be input to a WLS algorithm to determine correction Δx as follows:

$$Δ x = {( {H}^{T} W H )}^{- 1} {H}^{T} Wr \qquad ( Eqn . 1 )$$

where residual, r, is a difference between measured distances and expected distances at a seed location; weight, W, represents the importance of each measurement; and information about a satellite's position in the sky is represented by H. Once correction Δx is determined, it may be applied to the guess location (e.g., guess location 208 of FIG. 2) to obtain a more accurate position estimate (e.g., closer to actual location 210). The WLS algorithm may find Δx by running iteratively until convergence (corrections become small). As noted, however, traditional techniques may take a long amount of time to determine a position estimate for a first fix. And although machine learning (ML) models have been utilized to process residual information in the past, techniques have suffered with respect to how to accurately represent residual information for processing by such ML models.

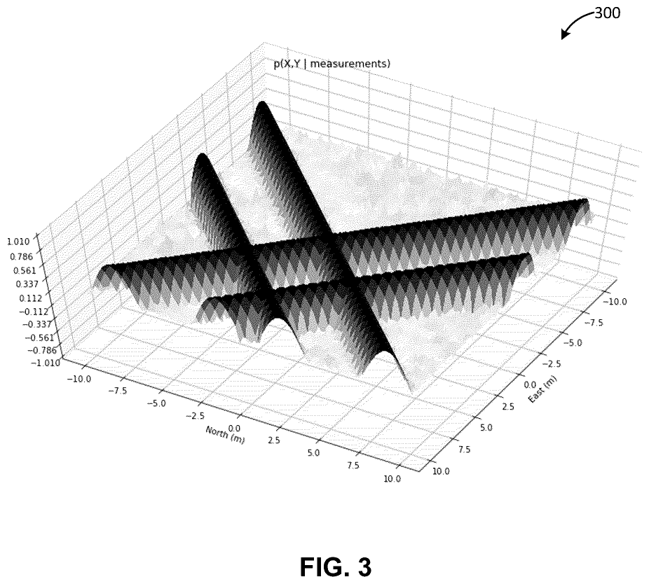

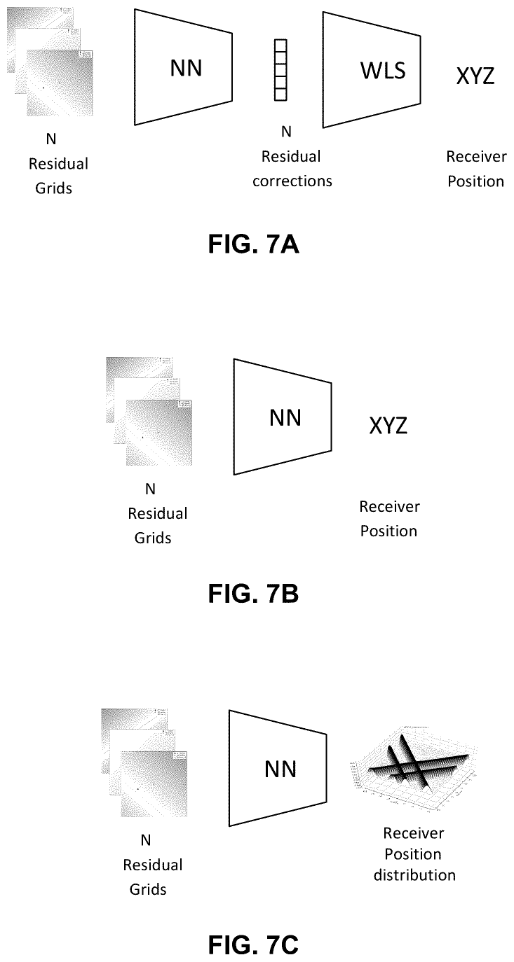

Embodiments herein address these and other issues by representing residuals using a grid-based approach, representing how residuals change over different geographical locations within a grid. As such, embodiments may better capture situations in which multipath and NLOS cause multi-modality of a location distribution, where multiple locations have a local minimum for a subset of residuals. (An example of multi-model location distribution is illustrated in graph 300 of FIG. 3.) Moreover, because grid representations may have a fixed size, they can be efficiently and effectively processed using Convolutional Neural Networks (CNNs), as if they were images. Moreover, a grid-based representation may pair well with other image-based sources, like street maps and terrain/building heights. (These are useful priors for localization, when available.) Depending on desired functionality, the granularity/size of the input grid could be controlled depending on the uncertainty in the initial guess location. Iterative refinement also may be applied to gradually zoom in until the predicted displacement is under a certain threshold. Moreover, as further discussed with respect to FIGS. 7A-7C (described below), depending on the neural network (NN) definition, the ML model can be defined to be integrated into traditional WLS triangulation, or may be used to directly predict the output location (e.g., XYZ coordinates), which may be independent from WLS (as WLS can lead to suboptimal predictions when weights or residuals are noisy).

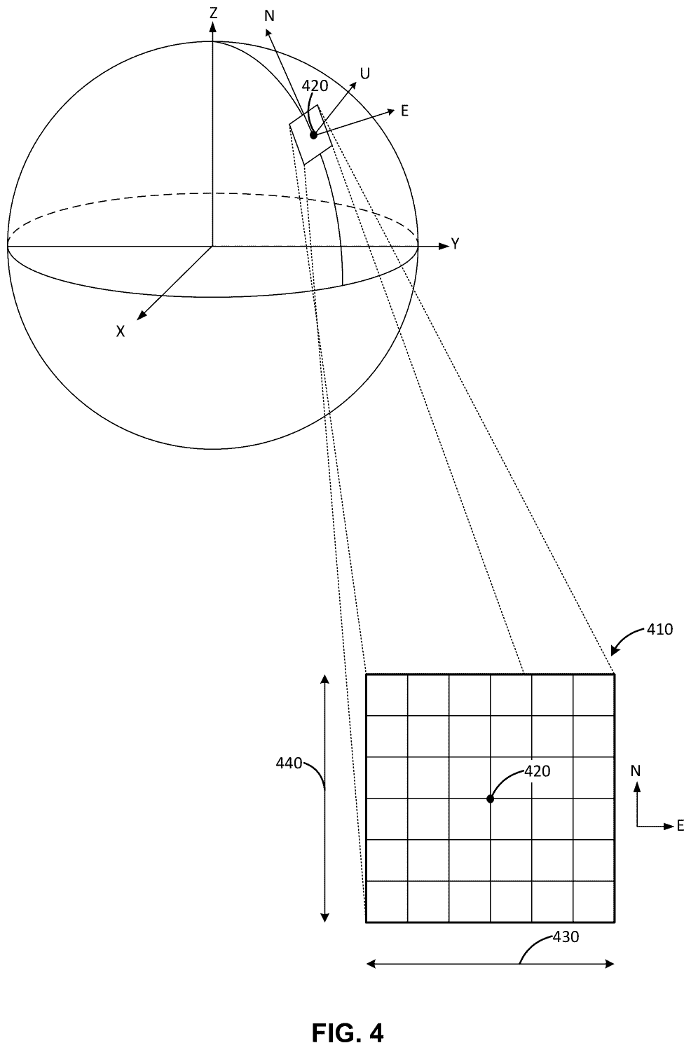

FIG. 4 is an illustration of aspects of how residuals may be represented in a grid, according to some embodiments. Here, a grid 410 may be derived from a guess or “seed” location 420 of a GNSS receiver for which positioning is to be made. The seed location 420 may be obtained from any of a variety of sources, including the location of a cell tower (e.g., in cases where the GNSS receiver has a cellular radio and is able to detect and/or communicate with cellular towers) or access point to another type of communication network (e.g., Wi-Fi access point), last known location of the GNSS receiver, user input, location beacons (e.g., Bluetooth beacons), radio transmissions/broadcasts, or the like. The grid 410 may then be formed using the seed location 420 as, for example, a center point on an East/North/Up (ENU) plane from which the 2D grid 410 is derived.

As a person of ordinary skill in the art will appreciate, embodiments may include one or more variations to the representation illustrated in FIG. 4. This can include, for example, using a coordinate system other than North-East for grid 410, having grids of different sizes (e.g., 100 m per side, 1 km per side, etc.), grids with different widths 430 and/or heights 440, have non-rectangular grids (e.g., circular, hexagonal, triangular, etc.). Because the Earth's surface is essentially flat at small scales, grid 410 on the tangent plane may approximate the Earth's surface really well for many applications, for example, when in a range of a few hundred meters (e.g., width 420 and/or height 440). Further, the granularity of the data represented by grid 410 can vary. Depending on desired functionality, data may be determined for grid points at a sub-meter level, meter level, or level greater than a meter (e.g., every 2 m, 5 m, 10 m, 50 m, etc.).

In any case, grid 410 may represent a geographical region for which residual information can be determined. The resulting grid of residual information, referred to herein as a “residual grid” or “grid representation,” can then be processed by an ML model (e.g., CNN) which extracts features from the grid. It can be noted that, although features extracted from the grid may be described herein as “visual” features, embodiments are not so limited. As noted, graphs may be processed in a manner similar to images in some embodiments. However, embodiments are not necessarily limited to representing and/or processing residual grids in such a “visual” manner.

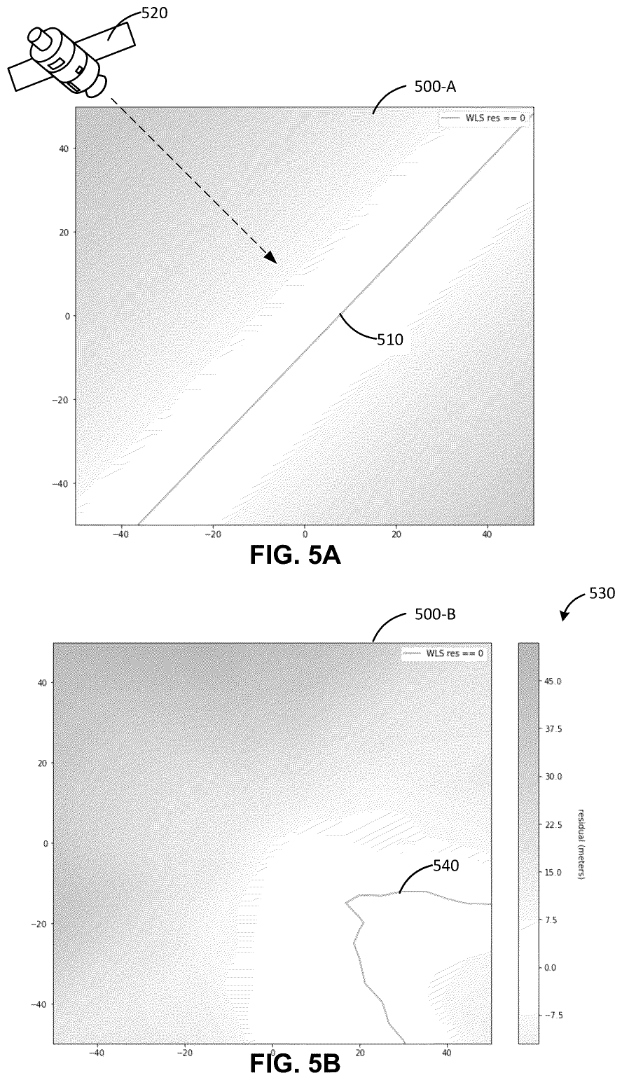

FIGS. 5A and 5B illustrate residual grids 500-A and 500-B, which illustrate aspects of residual grid creation for a pseudorange measurement, according to an embodiment. Once the seed location for a GNSS receiver is determined and the dimensions of the grid are established (e.g., as explained with respect to FIG. 4), the GNSS receiver may then perform pseudorange measurements of RF signals transmitted by GNSS SVs. As noted elsewhere herein, signals from a plurality of SVs (e.g., four or more) may need to be measured to obtain the location of the GNSS receiver. Further, some satellites may transmit multiple signals (e.g., signals on multiple bands, such as L1, L2, L5, etc.). For each measurement, an initial residual grid 500-A and a modified residual grid 500-B may be determined (e.g., by the GNSS receiver and/or a device into which the GNSS receiver is incorporated).

For a given measurement, the initial grid 500-A may be generated based on the measured pseudorange and the location of the respective SV that transmits the RF signal on which the measurement is based. In FIG. 5A (and other residual grids included in the appended figures), line 510 represents locations within grid 500-A where there is no residual. In other words, line 510 represents possible locations of the GNSS receiver, given the determined pseudorange from the transmitting SV 520, prior to correcting for errors in the pseudorange measurement. Thus, line 510 represents locations within the initial grid 500-A that are equidistant from the transmitting SV 520 for a measured pseudorange. Thus, the location and slope of the 510 depend on the measured pseudorange and location (e.g., azimuth, elevation) of the satellite 520 relative to locations within the initial grid 500-A. In FIGS. 5A and 5B, the larger the residual error, the darker the shading (as indicated in the scale 530 of FIG. 5B). According to some embodiments, the residual may be calculated using the following equation:

$${ε}_{residual} = P {R}_{meas} - dist ( SV , RCV ) + {ε}_{known} + c * Δ {T}_{RCV} , \qquad ( Eqn . 2 )$$

where ε_{residual} is the residual value (e.g., in meters), PRₘₑₐₛ is the pseudorange measurement, dist(SV, RCV) is the distance between the SV and the GNSS receiver, ε_{known} is noise bias (that may be modeled), c is the speed of the traveling signal (the speed of light), and ΔT_{RCV} is receiver clock bias (which also may be modeled).

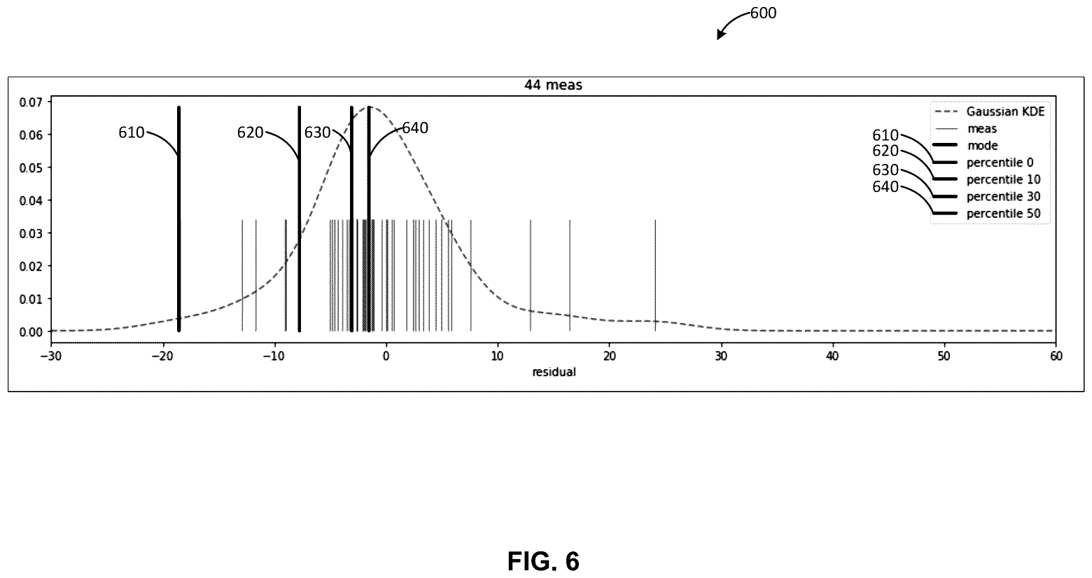

The modified residual grid 500-B is a result of modifying the initial residual grid 500-A to reflect various errors/noise factors, which may be known or modeled. This may include, for example, ionospheric delay, tropospheric delay, Earth's rotation correction, constellation time bias, or any combination thereof. This may also include receiver clock bias, which is described in more detail hereafter with respect to FIG. 6. As shown by line 540, the possible locations (e.g., candidate locations) for the GNSS receiver may be greatly impacted by accounting for these various errors/noise factors.

With respect to receiver clock bias estimation, the input residual may include an unknown receiver clock bias much larger than the residual value itself. An accurate determination of when a signal is received can result in an accurate estimation of receiver clock bias. Typically a first-received signal represents the direct signal, whereas subsequently-received signals are often the result of multipath. However, a signal interpreted as a first-received signal may be the result of noise. Thus, a robust receiver clock estimator may account for such noise. An example of this is illustrated in FIG. 6.

FIG. 6 illustrates graph 600, indicating the timing of when measurements are made by a GNSS receiver of an incoming signal. Here, a series of measurements (illustrated by the shorter vertical lines) is represented by a Gaussian kernel density estimation (KDE) (the dotted curve). Markers are shown illustrating the various percentiles of the KDE, including percentile 0 (marker 610), percentile 10 (marker 620), percentile 30 (marker 630), and percentile 50 (marker 640). According to some embodiments, rather than using percentile zero (marker 610) as a first-received signal, percentile 10 (marker 620) may be used as a “robust” first arrival time, to help reduce the likelihood that the first arrival time is triggered due to noise. All time biases may be centered around this time (marker 620) due to the fact that all measurements in a position fix will have the same time bias. This can be done for all locations on a grid. And because the effect is nonlinear, it can cause the transition from an (approximately) linear series of candidate positions in an initial residual grid (e.g., line 510 in FIG. 5A) to a nonlinear series of candidate positions in a modified residual grid (e.g., line 540 in FIG. 5B).

Additionally or alternatively, this same method can be applied to estimate the constellation time bias, if unknown. To estimate the constellation time bias, embodiments may apply the statistics independently for each set of measurements coming from different GNSS constellations. For example, embodiments may find the 10th percentile among all GPS-L1 satellites to be the constellation bias for GPS-L1.

As previously indicated, residual grids can be used to train machine learning models (specifically, neural networks (NNs)) to provide prompt and accurate first fixed positioning of a GNSS receiver. FIGS. 7A-7C illustrate, at a high level, how this may be done according to some embodiments. In particular, FIGS. 7A-7C illustrate (from left to right) processes by which N residual grids (from N pseudorange measurements) may be processed to provide GNSS receiver position:

FIG. 7A depicts a way in which residual grids may be inserted into traditional techniques in which residuals are reduced using WLS fitting: a neural network is used to process residual grids made from measurements by the GNSS receiver location, producing residual corrections that are then fed to WLS, which provides the receiver position. Thus, residual grids may be “plugged in” to traditional algorithms for receiver position determination.
FIG. 7B depicts a second technique, which omits WLS fitting and allows the neural network to produce the GNSS receiver position directly from the residual grids.
FIG. 7C depicts a third technique, which produces receiver position distribution rather than a specific receiver position or residual corrections. This can allow for, for example, a fusion-based location determination to be made based on the receiver position distribution fused with data from other sources (e.g., maps, user input, historical information, etc.)

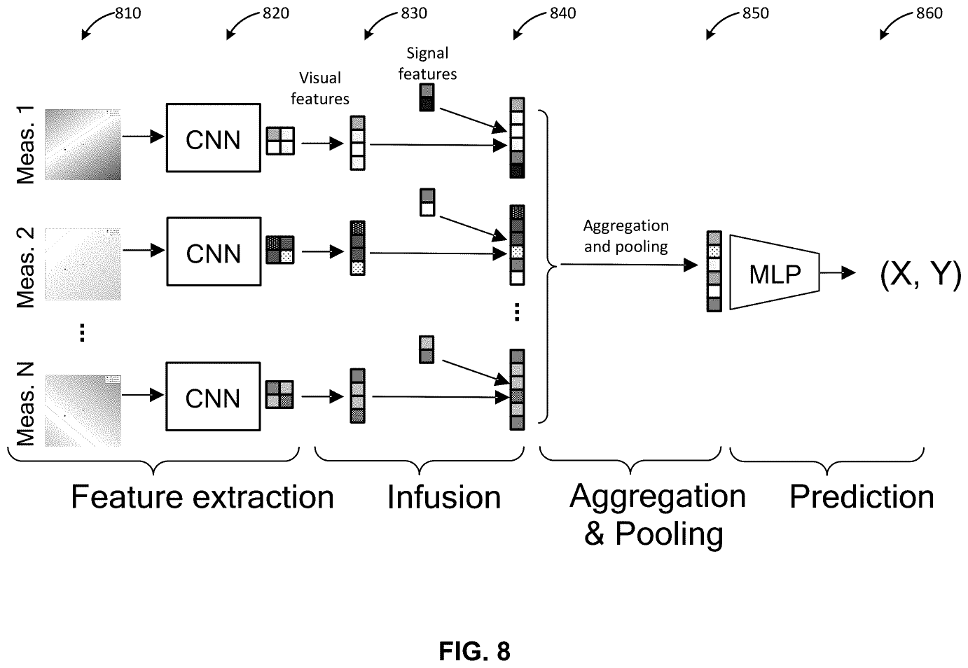

FIG. 8 is an illustration of an embodiment for providing end-to-end GNSS positioning with residual grids, according to an embodiment. Here, the input includes residual grids and the output is a predicted location (X, Y). (Some embodiments may further include Z, or altitude.) Thus, the embodiment illustrated in FIG. 8 may be one way of implementing a position determination technique as illustrated in FIG. 7B.

At a high level, the embodiment includes the following operations. With respect to feature extraction, for each pseudorange measurement made by a GNSS receiver at a given location, a residual grid of candidate locations for the GNSS receiver may be created (e.g., using the techniques described herein above), as illustrated in operation 810. Each of these residual grids can then be processed by a respective CNN, as illustrated at operation 820. Specifically, according to some embodiments, each CNN may process its respective residual grid independently. This may result in an output of values (represented as differently-shaded boxes) indicative of identified visual features for each residual grid, which may be organized into respective vectors (operation 830).

A further infusion operation may be performed (operation 840) in which output visual features may be infused with signal features for each respective pseudorange measurement. Here, signal features may include one or more features of the signal corresponding to the measurement from which the respective residual grid is made. This can include, for example, features such as CNo, elevation, signal strength, and so forth.

The infused data may then be aggregated and pooled (operation 850) in accordance with any of a variety of techniques for doing so. Aggregation methods may include, for example, self-attention, graph neural networks (GNNs) satellite angular distance, and the like. Pooling methods may include averaging, maximums, weighted averages by signal features, etc. Some examples of aggregation and pooling are described hereafter in particular embodiments.

Lastly, aggregated/pooled features may be fed through a multi-layer Perceptron (MLP) for predicting the position coordinates of the GNSS receiver, as indicated at operation 860. Again, depending on desired functionality and available location information, the predicted position, or estimated location, may include a two-dimensional or three-dimensional position.

With respect to aggregation, techniques may be used to propagate information across measurements, indicating relationships that may exist between measurements. This additional information is believed to increase the accuracy of residual grid-based positioning as described herein. For example, measurements from the same or nearby satellites may be aligned in a line of sight (LOS) scenario, while they might be inconsistent in the case of NLOS. Not only may propagating information across measurements increase the accuracy of residual grid-based positioning, but it may also increase the accuracy of any positioning in which residual information for measurements is processed independently.

As previously noted, GNNs are one way to aggregate processed residual information. Not only this, GNNs may consider relationships between measurements during aggregation. According to some embodiments, graphs may be created to represent one or more different types of relationships between measurements. In such embodiments, graphs may be created where nodes in the graph represent different measurements, and edge features (e.g., connections between nodes representative of relationships between the nodes) may represent, for example, whether measurements are of signals from the same satellite, same frequency, and angular distance between satellites corresponding to the measurements (e.g., on the hemisphere, on the azimuth component, decomposed in azimuth and elevation components), a difference between residuals, or the like. As such, edge features may be represented by a binary indication (e.g., same satellite, same frequency) or some number (e.g., angular distance, residual difference).

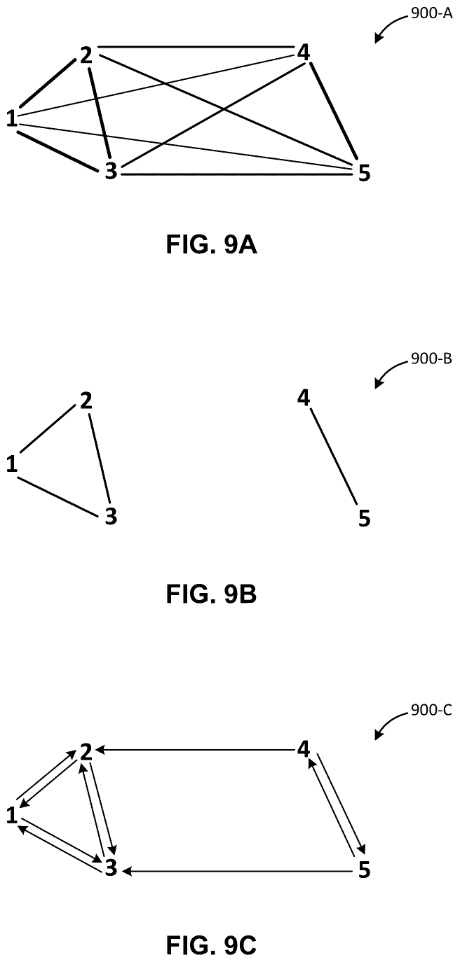

Additionally or alternatively, different types of graphs may be used and may depend on the type of information they represent. FIGS. 9A-9C illustrate examples of different types of graphs that may be used to represent angular distance for five different measurements. The graphs in FIGS. 9A-9C are shown in order of decreasing expressiveness and increasing efficiency, where the graph 900-A of FIG. 9A is the most expressive/least efficient, and FIG. 9C is the least expressive/most efficient.

FIG. 9A is an illustration of an example of a “complete” graph 900-A. In a complete graph, edges (relationships) between all measurements (represented in FIGS. 9A-9C as numerals 1-5) are provided. Angular distance may be represented by edges having a value from 0 to pi, which is visually represented in FIG. 9A as line thickness of the edges (the thicker the line, the closer the relationship/lower the angular distance).

FIG. 9B is an illustration of an example of a “sparse” graph 900-B. In a sparse graph, only a subset of relationships is represented. In the example of graph 900-B, edges are used only to represent relationships in which angular distance between satellites corresponding to the measurements is less than a threshold distance. Depending on desired functionality, edges may comprise a numerical value indicating the angular distance or simply a binary value (indicating that the angular distance is less than the threshold).

FIG. 9C is an illustration of an example of a k nearest neighbor (k-NN) graph. In a k-NN graph, only a subset of relationships is represented. However, rather than a sparse graph in which all edges having a value less than a threshold are used, a k-NN graph has edges showing the relationships having the lowest angular distance, up to a certain number, k. The value of k may be predetermined and/or may be set dynamically (e.g., depending on the number of measurements, angular distances, available processing power and/or other resources, etc.).

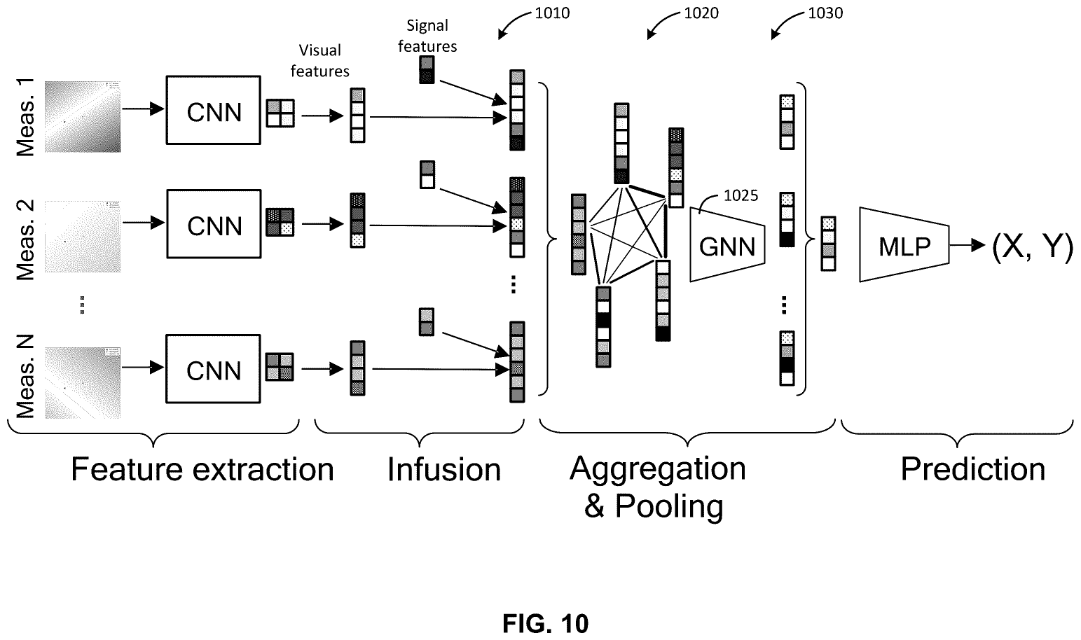

FIG. 10 illustrates how a GNN may be used in an end-to-end GNSS positioning method similar to the one illustrated in FIG. 8, according to an embodiment. As illustrated, a GNN can be inserted into the aggregation and pooling portion of the method. More specifically, after the infusion of signal features at operation 1010 (similar to FIG. 8), relationships can be identified between the features of the various measurements, and one or more graphs may be created to represent these relationships, as illustrated at operation 1020. (In the example shown in FIG. 10, relationships are illustrated as weighted edges, where line thickness reflects the weight of the edge.) Each graph of the one or more graphs may include all measurements (N), or a subset thereof. The graphs may then be processed by a GNN 1025, as illustrated at operation 1030, and subsequently aggregated for location prediction (similar to FIG. 8). It can be noted that, according to some embodiments, the GNN 1025 may consider not only the graph, but also the underlying features (e.g., signal strength and/or other visual or signal features that could fall into patterns recognizable by the GNN). Depending on desired functionality, different architectures may use information differently. These differences may include, for example, propagating information based on different subsets of binary edges, edge values, feature values, and relations between node features.

As previously noted, some graph types are more easily processed than others. Using a k-NN graph, for example, may result in quicker processing than using a complete graph. However, using a k-NN graph may result in less accuracy than using a complete graph, due to the fact that it has less information. With this in mind, some embodiments may utilize a simplified graph neural network (e.g., with a sparse k-NN graph), but may further incorporate a global feature array.

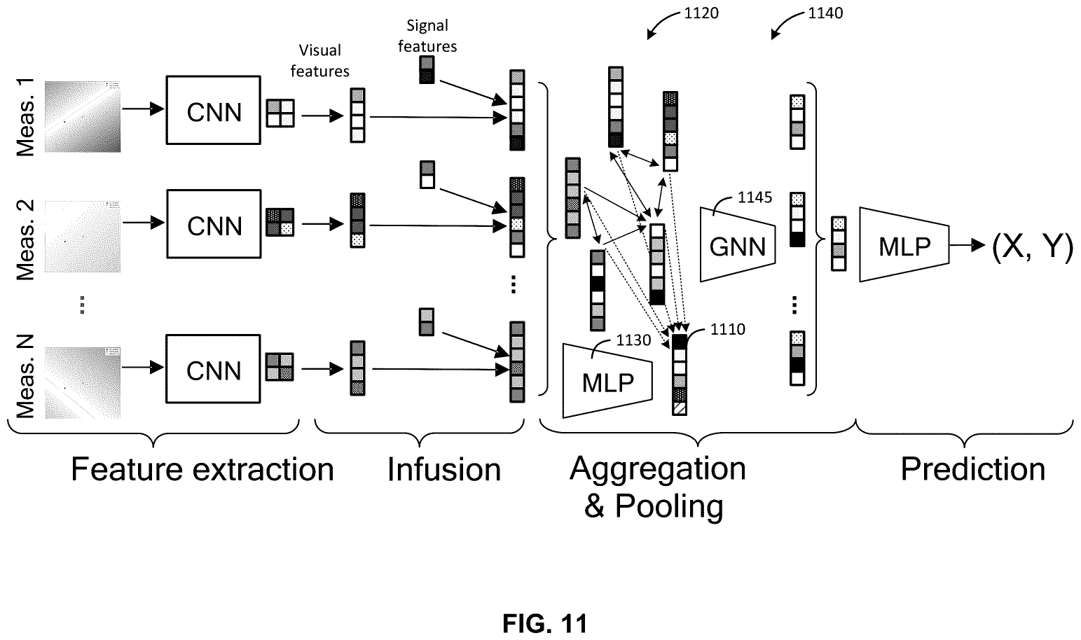

FIG. 11 illustrates how a global feature array 1110 may be used in an end-to-end GNSS positioning method similar to the one illustrated in FIGS. 8 and 10, according to an embodiment. Here, rather than using a complete graph, the process includes using a sparse k-NN graph at operation 1120. Further, however, an MLP 1130 is used to compute global features for all measurements, creating the global feature array 1110. The global feature array 1110 can then be processed with the graphs at operation 1140, similar to FIG. 10.

More specifically, the process for utilizing a global feature array 1110 may include the following operations. One or more k-NN graphs may be formed from signal features of the pseudorange measurements (e.g., all or a subset of the N measurements) in a manner similar to the one previously described with respect to FIG. 10. Here, however, the number of edges is fixed to k for efficient processing. The remaining information (from the removed edges) may be captured by aggregating the information over the whole graph in a global feature array. In other words, the MLP 1130 can use the output of the infusion operation to identify/compute global features for all N pseudorange measurements. These global features may then be combined with the k-NN graph(s) and processed by the GNN 1145 at operation 1140. In some experimental results, the usage of a global feature array in this manner resulted in a relative improvement in horizontal error (compared with GNN processing without a global feature array) of 2.3-3.4%.

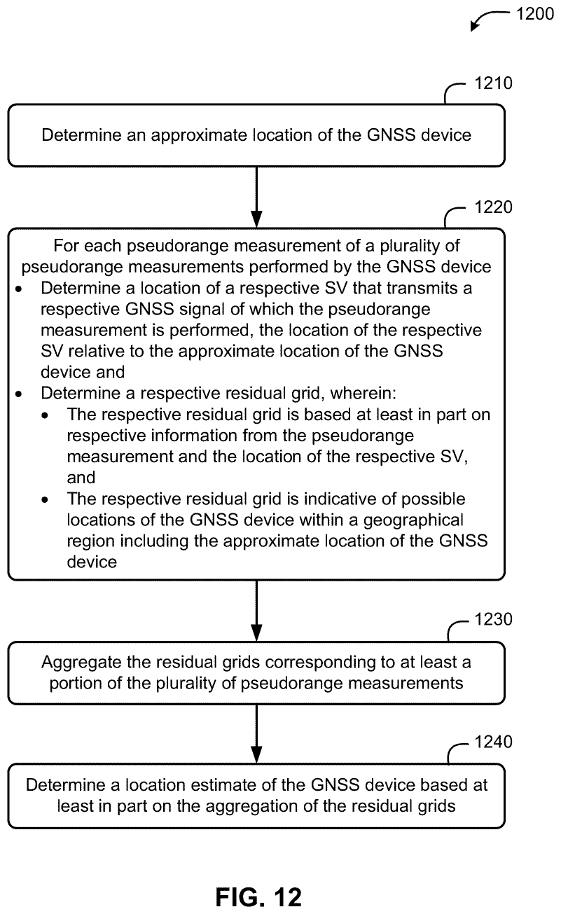

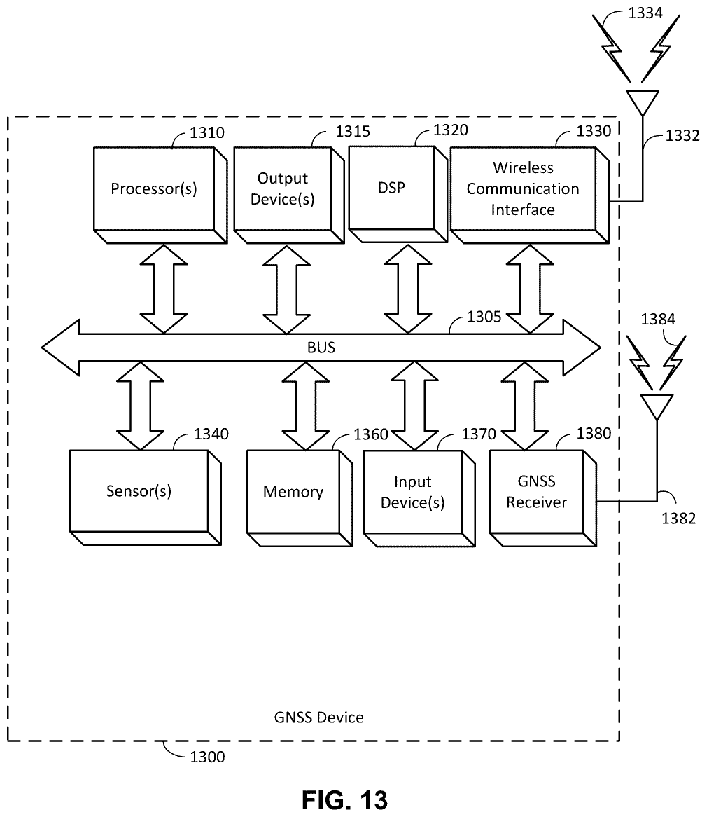

FIG. 12 is a flow diagram of a method 1200 of positioning a GNSS device using residual grid representation, according to an embodiment. Means for performing the functionality illustrated in one or more of the blocks shown in FIG. 12 may be performed by hardware and/or software components of a GNSS device (e.g., an electronic device comprising or coupled with a GNSS device). Example components of a GNSS device are illustrated in FIG. 13, which is described in more detail below.

At block 1210, the functionality comprises determining an approximate location of the GNSS device. Here, the approximate location of the GNSS device may comprise a guess or see location, as described elsewhere herein. Further, as indicated, this location may be obtained from any of a variety of sources, including a known location of a wireless transmitter from which wireless transmissions are received (e.g., a cell tower, Wi-Fi access point, etc.), a last known location of the GNSS device, user input, data included in location beacons, radio transmissions/broadcasts, or the like.

Means for performing functionality at block 1210 may comprise processor(s) 1310, digital signal processor (DSP) 1320, wireless communication interface 1330, sensor(s) 1340, memory 1360, GNSS receiver 1380, and/or other components of a GNSS device 1300 it as illustrated in FIG. 13.

At block 1220, the functionality comprises, for each pseudorange measurement of a plurality of pseudorange measurements performed by the GNSS device, determining a location of a respective SV that transmits a respective GNSS signal of which the pseudorange measurement is performed, the location of the respective SV relative to the approximate location of the GNSS device and determining a respective residual grid, wherein: the respective residual grid is based at least in part on respective information from the pseudorange measurement and the location of the respective SV, and the respective residual grid is indicative of possible locations of the GNSS device within a geographical region including the approximate location of the GNSS device. As noted previously, each pseudorange measurement may correspond to a different RF signal. Some SVs may transmit multiple signals (e.g., using different frequency bands). The location of the respective SV may be derived from ephemeris data obtained from a data source (e.g., a server or other data resource), including the SV itself (which may broadcast ephemeris data). The position of the respective SV corresponding to a given measurement relative to the approximate location of the GNSS device may be determined using simple modeling based on the ephemeris data and the approximate location of the GNSS device. Further, the respective residual grid may be determined as described herein. Granularity, size, shape, and/or other aspects of residual grids may vary, depending on desired functionality, processing concerns, and/or other factors.

Means for performing functionality at block 1220 may comprise processor(s) 1310, digital signal processor (DSP) 1320, wireless communication interface 1330, sensor(s) 1340, memory 1360, GNSS receiver 1380, and/or other components of a GNSS device 1300 it as illustrated in FIG. 13.

At block 1230, the functionality comprises aggregating the residual grids corresponding to at least a portion of the plurality of pseudorange measurements. As described herein, this may be done using a variety of data processing means, which may include, in some embodiments, using a GNN.

Means for performing functionality at block 1230 may comprise processor(s) 1310, digital signal processor (DSP) 1320, wireless communication interface 1330, sensor(s) 1340, memory 1360, GNSS receiver 1380, and/or other components of a GNSS device 1300 it as illustrated in FIG. 13.

At block 1240, the functionality comprises determining a location estimate of the GNSS device based at least in part on the aggregation of the residual grids. As illustrated in FIGS. 7A-7C, such determination may be performed in different ways. For example, according to some embodiments, determining the location estimate of the GNSS device based at least in part on the aggregation of the residual grids may comprise determining residual corrections based at least in part on the aggregation of the residual grids and determining the location estimate performing by performing weighted least squares (WLS) using the residual corrections (e.g., as shown in FIG. 7A). Additionally or alternatively, determining the location estimate of the GNSS device based at least in part on the aggregation of the residual grids may comprise processing the aggregation of the residual grids using a MLP (e.g., which may correspond with FIG. 7B, and other embodiments described herein). Additionally or alternatively, determining the location estimate of the GNSS device based at least in part on the aggregation of the residual grids may comprise processing the aggregation of the residual grids to determine a GNSS device position distribution and determining the location estimate from the GNSS device position distribution (e.g., as illustrated in FIG. 7C).

Means for performing functionality at block 1240 may comprise processor(s) 1310, digital signal processor (DSP) 1320, wireless communication interface 1330, sensor(s) 1340, memory 1360, GNSS receiver 1380, and/or other components of a GNSS device 1300 it as illustrated in FIG. 13.

Embodiments of method 1200 may include one or more additional features, as indicated in other embodiments described herein. For example, according to some embodiments, determining the respective residual grid for each pseudorange measurement of the plurality of pseudorange measurements may comprise, for each pseudorange measurement of a plurality of pseudorange measurements, determining a respective initial residual grid based at least in part on the respective pseudorange measurement information and the location of the respective SV, and determining the respective residual grid based at least in part on modifying the respective initial residual grid using error correction for the respective pseudorange measurement information. Examples of such a process are described herein with respect to FIGS. 5A and 5B. In such embodiments, the error correction may correct for receiver clock bias, ionospheric delay, tropospheric delay, constellation time bias, rotation of the Earth, or any combination thereof. In such embodiments, for at least one pseudorange measurement of the plurality of pseudorange measurements, the receiver clock bias is independently applied to a plurality of locations within the respective residual grid.

As noted herein, aggregation may occur in various ways, including those described with respect to FIGS. 8, 10, and 11. For example, aggregating the residual grids corresponding to at least a portion of the plurality of pseudorange measurements may comprise processing each of the residual grids corresponding to the at least a portion of the pseudorange measurements with a respective convolutional neural network (CNN) and combining outputs of the CNNs corresponding to the at least a portion of the pseudorange measurements. Such embodiments may further comprise, for each pseudorange measurement of the at least a portion of the plurality of pseudorange measurements, including one or more respective features of the respective GNSS signal on which the pseudorange measurement is performed, prior to combining the outputs of the CNNs. Such embodiments are described herein with respect to FIG. 8, for example. These features may include signal features and/or other features, such as features relating to the satellites: constellation type, elevation, azimuth, etc. Additionally or alternatively, aggregating the residual grids may comprise creating a graph representative of relationships between pairs of pseudorange measurements of at least a subset of the plurality of pseudorange measurements, processing the at least a subset of the plurality of pseudorange measurements with a graph neural network (GNN), and pooling outputs of the GNN from the processing. Such embodiments are described herein with respect to FIG. 10. In such embodiments, the relationships between pairs of pseudorange measurements may be indicative of whether the pairs of pseudorange measurements correspond to the same SV, whether the pseudorange measurements correspond to the same GNSS frequency band, an angular distance between SVs corresponding to a pair of pseudorange measurements, a difference between residuals of the pair of pseudorange measurements, or any combination thereof. As described herein, according to some embodiments, the relationships between pairs of pseudorange measurements may be indicative of the angular distance between SVs corresponding to a pair of pseudorange measurements, and wherein the graph comprises a complete graph comprising relationships between all pairs of pairs of pseudorange measurements in the graph (e.g., a complete graph), the graph comprises a sparce graph comprising relationships between pairs of pseudorange measurements in the graph for which the angular distance between SVs is less than a threshold angular distance, or the graph comprises a k nearest neighbor (k-NN) graph of comprising relationships between pairs of pseudorange measurements in the graph for having the lowest angular distance between SVs up to a number k. Some embodiments may further comprise extracting a set of global features of the plurality of pseudorange measurements, wherein the GNN further processes the set of global features (e.g., as explained herein with respect to FIG. 11).

As described herein, ML models such as CNNs, GNNs, MLPs may be trained in accordance with known techniques. For example, as a person of ordinary skill in the art will appreciate, ML models may be trained by taking measurements at known locations and training models to reduce residuals, estimate location, output location distribution accordingly. Trained ML models may then be used subsequently in the field as described herein with new measurements and locations.

FIG. 13 is a block diagram of an embodiment of a GNSS device 1300, which can be utilized as described herein above (e.g., in association with FIGS. 1-12). In some embodiments, GNSS device 1300 can perform one or more operations associated with one or more of positioning schemes of FIG. 8, 10, or 11, and/or method 1200 of FIG. 12. It should be noted that FIG. 13 is meant only to provide a generalized illustration of various components, any or all of which may be utilized as appropriate. It can be noted that, in some instances, components illustrated by FIG. 13 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 13.

The GNSS device 1300 is shown comprising hardware elements that can be electrically coupled via a bus 1305 (or may otherwise be in communication, as appropriate). The hardware elements may include a processor(s) 1310 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1310 may comprise one or more processing units, which may be housed in a single integrated circuit (IC) or multiple ICs. As shown in FIG. 13, some embodiments may have a separate DSP 1320, depending on desired functionality. Location determination and/or other determinations based on wireless communication may be provided in the processor(s) 1310 and/or wireless communication interface 1330 (discussed below). The GNSS device 1300 also can include one or more input devices 1370, which can include without limitation one or more keyboards, touch screens, touch pads, microphones, buttons, dials, switches, and/or the like; and one or more output devices 1315, which can include without limitation one or more displays (e.g., touch screens), light emitting diodes (LEDs), speakers, and/or the like.

The GNSS device 1300 may also include a wireless communication interface 1330, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the GNSS device 1300 to communicate with other devices as described in the embodiments above. The wireless communication interface 1330 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1332 that send and/or receive wireless signals 1334. According to some embodiments, the wireless communication antenna(s) 1332 may comprise a plurality of discrete antennas, antenna arrays, or any combination thereof. The antenna(s) 1332 may be capable of transmitting and receiving wireless signals using beams (e.g., Tx beams and Rx beams). Beam formation may be performed using digital and/or analog beam formation techniques, with respective digital and/or analog circuitry. The wireless communication interface 1330 may include such circuitry.

Depending on desired functionality, the wireless communication interface 1330 may comprise a separate receiver and transmitter, or any combination of transceivers, transmitters, and/or receivers to communicate with base stations (e.g., ng-eNBs and gNBs) and other terrestrial transceivers, such as wireless devices and access points. The GNSS device 1300 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The GNSS device 1300 can further include sensor(s) 1340. Sensor(s) 1340 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the GNSS device 1300 may also include a Global Navigation Satellite System (GNSS) receiver 1380 capable of receiving signals 1384 from one or more GNSS satellites using an antenna 1382 (which could be the same as antenna 1332). Positioning based on GNSS signal measurement can be utilized to complement and/or incorporate the techniques described herein. The GNSS receiver 1380 can extract a position of the GNSS device 1300, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1380 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1380 is illustrated in FIG. 13 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1310, DSP 1320, and/or a processor within the wireless communication interface 1330 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1310 or DSP 1320.

The GNSS device 1300 may further include and/or be in communication with a memory 1360. The memory 1360 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1360 of the GNSS device 1300 also can comprise software elements (not shown in FIG. 13), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1360 that are executable by the GNSS device 1300 (and/or processor(s) 1310 or DSP 1320 within GNSS device 1300). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method of positioning a global navigation satellite system (GNSS) device using residual grid representation, the method comprising: determining an approximate location of the GNSS device; for each pseudorange measurement of a plurality of pseudorange measurements performed by the GNSS device: determining a location of a respective satellite vehicle (SV) that transmits a respective GNSS signal of which the pseudorange measurement is performed, the location of the respective SV relative to the approximate location of the GNSS device; and determining a respective residual grid, wherein: the respective residual grid is based at least in part on respective information from the pseudorange measurement and the location of the respective SV, and the respective residual grid is indicative of possible locations of the GNSS device within a geographical region including the approximate location of the GNSS device; and aggregating the residual grids corresponding to at least a portion of the plurality of pseudorange measurements; and determining a location estimate of the GNSS device based at least in part on the aggregation of the residual grids.

Clause 2: The method of clause 1, wherein determining the respective residual grid for each pseudorange measurement of the plurality of pseudorange measurements comprises, for each pseudorange measurement of a plurality of pseudorange measurements: determining a respective initial residual grid based at least in part on the respective pseudorange measurement information, the approximate location of the GNSS device, and the location of the respective SV, and determining the respective residual grid based at least in part on modifying the respective initial residual grid using error correction for the respective pseudorange measurement information.

Clause 3: The method of clause 2 wherein the error correction corrects for: receiver clock bias, ionospheric delay, tropospheric delay, constellation time bias, rotation of the Earth, or any combination thereof.

Clause 4: The method of clause 3 wherein, for at least one pseudorange measurement of the plurality of pseudorange measurements, the receiver clock bias, the constellation time bias, or both, is independently applied to a plurality of locations within the respective residual grid.

Clause 5: The method of any one of clauses 1-4 wherein aggregating the residual grids corresponding to at least a portion of the plurality of pseudorange measurements comprises: processing each of the residual grids corresponding to the at least a portion of the pseudorange measurements with a respective convolutional neural network (CNN); and combining outputs of the CNNs corresponding to the at least a portion of the pseudorange measurements.

Clause 6: The method of clause 5 further comprising, for each pseudorange measurement of the at least a portion of the plurality of pseudorange measurements, including one or more respective features of the respective GNSS signal on which the pseudorange measurement is performed, prior to combining the outputs of the CNNs.

Clause 7: The method of any one of clauses 1-6 wherein aggregating the residual grids comprises: creating a graph representative of relationships between pairs of pseudorange measurements of at least a subset of the plurality of pseudorange measurements; processing the at least a subset of the plurality of pseudorange measurements with a graph neural network (GNN); and pooling outputs of the GNN from the processing.

Clause 8: The method of clause 7 wherein the relationships between pairs of pseudorange measurements are indicative of: whether the pairs of pseudorange measurements correspond to the same SV, whether the pseudorange measurements correspond to the same GNSS frequency band, an angular distance between SVs corresponding to a pair of pseudorange measurements, a difference between residuals of the pair of pseudorange measurements, or any combination thereof.

Clause 9: The method of clause 8 wherein the relationships between pairs of pseudorange measurements are indicative of the angular distance between SVs corresponding to a pair of pseudorange measurements, and wherein: the graph comprises a complete graph comprising relationships between all pairs of pairs of pseudorange measurements in the graph, the graph comprises a sparse graph comprising relationships between pairs of pseudorange measurements in the graph for which the angular distance between SVs is less than a threshold angular distance, or the graph comprises a k nearest neighbor (k-NN) graph of comprising relationships between pairs of pseudorange measurements in the graph for having the lowest angular distance between SVs up to a number k.

Clause 10: The method of any one of clauses 7-9 further comprising extracting a set of global features of the plurality of pseudorange measurements, wherein the GNN further processes the set of global features.

Clause 11: The method of any one of clauses 1-10 wherein determining the location estimate of the GNSS device based at least in part on the aggregation of the residual grids comprises: determining residual corrections based at least in part on the aggregation of the residual grids; and determining the location estimate by performing weighted least squares (WLS) using the residual corrections.

Clause 12: The method of any one of clauses 1-11 wherein determining the location estimate of the GNSS device based at least in part on the aggregation of the residual grids comprises processing the aggregation of the residual grids using a multi-layer perceptron (MLP).

Clause 13: The method of any one of clauses 1-12 wherein determining the location estimate of the GNSS device based at least in part on the aggregation of the residual grids comprises processing the aggregation of the residual grids to determine a GNSS device position distribution; and determining the location estimate from the GNSS device position distribution.

Clause 14: A method of positioning a global navigation satellite system (GNSS) device using residual grid representation, the method comprising: determining an approximate location of the GNSS device; for each pseudorange measurement of a plurality of pseudorange measurements performed by the GNSS device, determining respective residual information, wherein the respective residual information is based at least in part on respective information from the pseudorange measurement and the location of the respective SV; aggregating the residual information corresponding to at least a portion of the plurality of pseudorange measurements, wherein the aggregating comprises: creating a graph representative of relationships between pairs of pseudorange measurements of at least a subset of the plurality of pseudorange measurements, processing the at least a subset of the plurality of pseudorange measurements with a graph neural network (GNN), and pooling outputs of the GNN from the processing; and determining a location estimate of the GNSS device based at least in part on the aggregation of the residual information.

Clause 15: A global navigation satellite system (GNSS) device comprising: a GNSS receiver; a memory; and one or more processors communicatively coupled with the GNSS receiver and the memory, wherein the one or more processors are configured to: determine an approximate location of the GNSS device; for each pseudorange measurement of a plurality of pseudorange measurements performed by the GNSS device using the GNSS receiver: determine a location of a respective satellite vehicle (SV) that transmits a respective GNSS signal of which the pseudorange measurement is performed, the location of the respective SV relative to the approximate location of the GNSS device; and determine a respective residual grid, wherein: the respective residual grid is based at least in part on respective information from the pseudorange measurement and the location of the respective SV, and the respective residual grid is indicative of possible locations of the GNSS device within a geographical region including the approximate location of the GNSS device; and aggregate the residual grids corresponding to at least a portion of the plurality of pseudorange measurements; and determine a location estimate of the GNSS device based at least in part on the aggregation of the residual grids.

Clause 16: The GNSS device of clause 15, wherein, to determine the respective residual grid for each pseudorange measurement of the plurality of pseudorange measurements, the one or more processors are configured to, for each pseudorange measurement of a plurality of pseudorange measurements: determine a respective initial residual grid based at least in part on the respective pseudorange measurement information, the approximate location of the GNSS device, and the location of the respective SV, and determine the respective residual grid based at least in part on modifying the respective initial residual grid using error correction for the respective pseudorange measurement information.

Clause 17: The GNSS device of clause 16 wherein the one or more processors are configured to use the error correction to correct for: receiver clock bias, ionospheric delay, tropospheric delay, constellation time bias, rotation of the Earth, or any combination thereof.

Clause 18: The GNSS device of clause 17 wherein the one or more processors are configured to independently apply the receiver clock bias, the constellation time bias, or both, to a plurality of locations within the respective residual grid, for at least one pseudorange measurement of the plurality of pseudorange measurements.

Clause 19: The GNSS device of any one of clauses 15-18 wherein, to aggregate the residual grids corresponding to at least a portion of the plurality of pseudorange measurements, the one or more processors are configured to process each of the residual grids corresponding to the at least a portion of the pseudorange measurements with a respective convolutional neural network (CNN); and combine outputs of the CNNs corresponding to the at least a portion of the pseudorange measurements.

Clause 20: The GNSS device of clause 19 wherein the one or more processors are further configured to, for each pseudorange measurement of the at least a portion of the plurality of pseudorange measurements, include one or more respective features of the respective GNSS signal on which the pseudorange measurement is performed, prior to combining the outputs of the CNNs.

Clause 21: The GNSS device of any one of clauses 15-20 wherein, to aggregate the residual grids, the one or more processors are configured to create a graph representative of relationships between pairs of pseudorange measurements of at least a subset of the plurality of pseudorange measurements; process the at least a subset of the plurality of pseudorange measurements with a graph neural network (GNN); and pool outputs of the GNN from the processing.

Clause 22: The GNSS device of clause 21 wherein the one or more processors are configured to include an indication, in the relationships between pairs of pseudorange measurements, of: whether the pairs of pseudorange measurements correspond to the same SV, whether the pseudorange measurements correspond to the same GNSS frequency band, an angular distance between SVs corresponding to a pair of pseudorange measurements, a difference between residuals of the pair of pseudorange measurements, or any combination thereof.

Clause 23: The GNSS device of clause 22 wherein the one or more processors are configured to include an indication, in the relationships between pairs of pseudorange measurements, of the angular distance between SVs corresponding to a pair of pseudorange measurements, and wherein the one or more processors are configured to create the graph such that the graph comprises: a complete graph comprising relationships between all pairs of pairs of pseudorange measurements in the graph, a sparse graph comprising relationships between pairs of pseudorange measurements in the graph for which the angular distance between SVs is less than a threshold angular distance, or a k nearest neighbor (k-NN) graph of comprising relationships between pairs of pseudorange measurements in the graph for having the lowest angular distance between SVs up to a number k.

Clause 24: The GNSS device of any one of clauses 21-23 wherein the one or more processors are further configured to extract a set of global features of the plurality of pseudorange measurements, wherein the GNN further processes the set of global features.

Clause 25: The GNSS device of any one of clauses 15-24 wherein, to determine the location estimate of the GNSS device based at least in part on the aggregation of the residual grids, the one or more processors are configured to determine residual corrections based at least in part on the aggregation of the residual grids; and determine the location estimate by performing weighted least squares (WLS) using the residual corrections.

Clause 26: The GNSS device of any one of clauses 15-25 wherein, to determine the location estimate of the GNSS device based at least in part on the aggregation of the residual grids, the one or more processors are configured to process the aggregation of the residual grids using a multi-layer perceptron (MLP).

Clause 27: The GNSS device of any one of clauses 15-26 wherein, to determine the location estimate of the GNSS device based at least in part on the aggregation of the residual grids, the one or more processors are configured to process the aggregation of the residual grids to determine a GNSS device position distribution; and determine the location estimate from the GNSS device position distribution.

Clause 28: A global navigation satellite system (GNSS) device comprising: a GNSS receiver; a memory; and one or more processors communicatively coupled with the GNSS receiver and the memory, wherein the one or more processors are configured to: determine an approximate location of the GNSS device; for each pseudorange measurement of a plurality of pseudorange measurements performed by the GNSS device using the GNSS receiver, determine respective residual information, wherein the respective residual information is based at least in part on respective information from the pseudorange measurement and the location of the respective SV; aggregate the residual information corresponding to at least a portion of the plurality of pseudorange measurements, wherein the aggregating comprises: create a graph representative of relationships between pairs of pseudorange measurements of at least a subset of the plurality of pseudorange measurements, process the at least a subset of the plurality of pseudorange measurements with a graph neural network (GNN), and pooling outputs of the GNN from the processing; and determine a location estimate of the GNSS device based at least in part on the aggregation of the residual information.

Clause 29: An apparatus for positioning a global navigation satellite system (GNSS) device using residual grid representation, the apparatus comprising: means for determining an approximate location of the GNSS device; for each pseudorange measurement of a plurality of pseudorange measurements performed by the GNSS device: means for determining a location of a respective satellite vehicle (SV) that transmits a respective GNSS signal of which the pseudorange measurement is performed, the location of the respective SV relative to the approximate location of the GNSS device; and means for determining a respective residual grid, wherein: the respective residual grid is based at least in part on respective information from the pseudorange measurement and the location of the respective SV, and the respective residual grid is indicative of possible locations of the GNSS device within a geographical region including the approximate location of the GNSS device; and means for aggregating the residual grids corresponding to at least a portion of the plurality of pseudorange measurements; and means for determining a location estimate of the GNSS device based at least in part on the aggregation of the residual grids.

Clause 30: The apparatus of clause 29, wherein the means for determining the respective residual grid for each pseudorange measurement of the plurality of pseudorange measurements comprises means for, for each pseudorange measurement of a plurality of pseudorange measurements: determining a respective initial residual grid based at least in part on the respective pseudorange measurement information, the approximate location of the GNSS device, and the location of the respective SV, and determining the respective residual grid based at least in part on modifying the respective initial residual grid using error correction for the respective pseudorange measurement information.

Clause 31: The apparatus of clause 30 wherein the error correction corrects for: receiver clock bias, ionospheric delay, tropospheric delay, constellation time bias, rotation of the Earth, or any combination thereof.

Clause 32: The apparatus of clause 31 wherein, for at least one pseudorange measurement of the plurality of pseudorange measurements, the receiver clock bias, the constellation time bias, or both, is independently applied to a plurality of locations within the respective residual grid.

Clause 33: The apparatus of any one of clauses 29-32 wherein the means for aggregating the residual grids corresponding to at least a portion of the plurality of pseudorange measurements comprises: means for processing each of the residual grids corresponding to the at least a portion of the pseudorange measurements with a respective convolutional neural network (CNN); and means for combining outputs of the CNNs corresponding to the at least a portion of the pseudorange measurements.

Clause 34: The apparatus of clause 33 further comprising, for each pseudorange measurement of the at least a portion of the plurality of pseudorange measurements, including one or more respective features of the respective GNSS signal on which the pseudorange measurement is performed, prior to combining the outputs of the CNNs.

Clause 35: The apparatus of any one of clauses 29-34 wherein the means for aggregating the residual grids comprises: means for creating a graph representative of relationships between pairs of pseudorange measurements of at least a subset of the plurality of pseudorange measurements; means for processing the at least a subset of the plurality of pseudorange measurements with a graph neural network (GNN); and means for pooling outputs of the GNN from the processing.

Clause 36: The apparatus of clause 35 wherein the relationships between pairs of pseudorange measurements are indicative of: whether the pairs of pseudorange measurements correspond to the same SV, whether the pseudorange measurements correspond to the same GNSS frequency band, an angular distance between SVs corresponding to a pair of pseudorange measurements, a difference between residuals of the pair of pseudorange measurements, or any combination thereof.

Clause 37: The apparatus of clause 36 wherein the relationships between pairs of pseudorange measurements are indicative of the angular distance between SVs corresponding to a pair of pseudorange measurements, and wherein: the graph comprises a complete graph comprising relationships between all pairs of pairs of pseudorange measurements in the graph, the graph comprises a sparse graph comprising relationships between pairs of pseudorange measurements in the graph for which the angular distance between SVs is less than a threshold angular distance, or the graph comprises a k nearest neighbor (k-NN) graph of comprising relationships between pairs of pseudorange measurements in the graph for having the lowest angular distance between SVs up to a number k.

Clause 38: The apparatus of any one of clauses 35-37 further comprising means for extracting a set of global features of the plurality of pseudorange measurements, wherein the GNN further processes the set of global features.

Clause 39: The apparatus of any one of clauses 29-38 wherein the means for determining the location estimate of the GNSS device based at least in part on the aggregation of the residual grids comprises: means for determining residual corrections based at least in part on the aggregation of the residual grids; and means for determining the location estimate by performing weighted least squares (WLS) using the residual corrections.

Clause 40: The apparatus of any one of clauses 29-39 wherein the means for determining the location estimate of the GNSS device based at least in part on the aggregation of the residual grids comprises means for processing the aggregation of the residual grids using a multi-layer perceptron (MLP).

Clause 41: The apparatus of any one of clauses 29-40 wherein the means for determining the location estimate of the GNSS device based at least in part on the aggregation of the residual grids comprises: means for processing the aggregation of the residual grids to determine a GNSS device position distribution; and means for determining the location estimate from the GNSS device position distribution.

Clause 42: An apparatus for positioning a global navigation satellite system (GNSS) device using residual grid representation, the apparatus comprising: means for determining an approximate location of the GNSS device; for each pseudorange measurement of a plurality of pseudorange measurements performed by the GNSS device, determining respective residual information, wherein the respective residual information is based at least in part on respective information from the pseudorange measurement and the location of the respective SV; means for aggregating the residual information corresponding to at least a portion of the plurality of pseudorange measurements, wherein the aggregating comprises: means for creating a graph representative of relationships between pairs of pseudorange measurements of at least a subset of the plurality of pseudorange measurements, means for processing the at least a subset of the plurality of pseudorange measurements with a graph neural network (GNN), and pooling outputs of the GNN from the processing; and means for determining a location estimate of the GNSS device based at least in part on the aggregation of the residual information.

Clause 43: A non-transitory computer-readable medium storing instructions for positioning a global navigation satellite system (GNSS) device using residual grid representation, the instructions comprising code for: determining an approximate location of the GNSS device; for each pseudorange measurement of a plurality of pseudorange measurements performed by the GNSS device: determining a location of a respective satellite vehicle (SV) that transmits a respective GNSS signal of which the pseudorange measurement is performed, the location of the respective SV relative to the approximate location of the GNSS device; and determining a respective residual grid, wherein: the respective residual grid is based at least in part on respective information from the pseudorange measurement and the location of the respective SV, and the respective residual grid is indicative of possible locations of the GNSS device within a geographical region including the approximate location of the GNSS device; and aggregating the residual grids corresponding to at least a portion of the plurality of pseudorange measurements; and determining a location estimate of the GNSS device based at least in part on the aggregation of the residual grids.

Clause 44: The computer-readable medium of clause 43, wherein the code for determining the respective residual grid for each pseudorange measurement of the plurality of pseudorange measurements comprises code for, for each pseudorange measurement of a plurality of pseudorange measurements: determining a respective initial residual grid based at least in part on the respective pseudorange measurement information, the approximate location of the GNSS device, and the location of the respective SV, and determining the respective residual grid based at least in part on modifying the respective initial residual grid using error correction for the respective pseudorange measurement information.

Clause 45: The computer-readable medium of clause 44 wherein the error correction corrects for: receiver clock bias, ionospheric delay, tropospheric delay, constellation time bias, rotation of the Earth, or any combination thereof.

Clause 46: The computer-readable medium of clause 45 wherein, for at least one pseudorange measurement of the plurality of pseudorange measurements, the receiver clock bias, the constellation time bias, or both, is independently applied to a plurality of locations within the respective residual grid.

Clause 47: The computer-readable medium of any one of clauses 43-46 wherein the code for aggregating the residual grids corresponding to at least a portion of the plurality of pseudorange measurements comprises code for: processing each of the residual grids corresponding to the at least a portion of the pseudorange measurements with a respective convolutional neural network (CNN); and combining outputs of the CNNs corresponding to the at least a portion of the pseudorange measurements.

Clause 48: The computer-readable medium of clause 47 wherein the instructions further comprise code for, for each pseudorange measurement of the at least a portion of the plurality of pseudorange measurements, including one or more respective features of the respective GNSS signal on which the pseudorange measurement is performed, prior to combining the outputs of the CNNs.

Clause 49: The computer-readable medium of any one of clauses 43-48 wherein the code for aggregating the residual grids comprises code for: creating a graph representative of relationships between pairs of pseudorange measurements of at least a subset of the plurality of pseudorange measurements; processing the at least a subset of the plurality of pseudorange measurements with a graph neural network (GNN); and pooling outputs of the GNN from the processing.

Clause 50: The computer-readable medium of clause 49 wherein the relationships between pairs of pseudorange measurements are indicative of: whether the pairs of pseudorange measurements correspond to the same SV, whether the pseudorange measurements correspond to the same GNSS frequency band, an angular distance between SVs corresponding to a pair of pseudorange measurements, a difference between residuals of the pair of pseudorange measurements, or any combination thereof.

Clause 51: The computer-readable medium of clause 50 wherein the relationships between pairs of pseudorange measurements are indicative of the angular distance between SVs corresponding to a pair of pseudorange measurements, and wherein: the graph comprises a complete graph comprising relationships between all pairs of pairs of pseudorange measurements in the graph, the graph comprises a sparse graph comprising relationships between pairs of pseudorange measurements in the graph for which the angular distance between SVs is less than a threshold angular distance, or the graph comprises a k nearest neighbor (k-NN) graph of comprising relationships between pairs of pseudorange measurements in the graph for having the lowest angular distance between SVs up to a number k.

Clause 52: The computer-readable medium of any one of clauses 49-51 wherein the instructions further comprise code for extracting a set of global features of the plurality of pseudorange measurements, wherein the GNN further processes the set of global features.

Clause 53: The computer-readable medium of any one of clauses 43-52 wherein the code for determining the location estimate of the GNSS device based at least in part on the aggregation of the residual grids comprises code for: determining residual corrections based at least in part on the aggregation of the residual grids; and determining the location estimate by performing weighted least squares (WLS) using the residual corrections.

Clause 54: The computer-readable medium of any one of clauses 43-53 wherein the code for determining the location estimate of the GNSS device based at least in part on the aggregation of the residual grids comprises code for processing the aggregation of the residual grids using a multi-layer perceptron (MLP).

Clause 55: The computer-readable medium of any one of clauses 43-54 wherein the code for determining the location estimate of the GNSS device based at least in part on the aggregation of the residual grids comprises code for: processing the aggregation of the residual grids to determine a GNSS device position distribution; and determining the location estimate from the GNSS device position distribution.

Clause 56: A non-transitory computer-readable medium storing instructions for positioning a global navigation satellite system (GNSS) device using residual grid representation, the instructions comprising code for: determining an approximate location of the GNSS device; for each pseudorange measurement of a plurality of pseudorange measurements performed by the GNSS device, determining respective residual information, wherein the respective residual information is based at least in part on respective information from the pseudorange measurement and the location of the respective SV; aggregating the residual information corresponding to at least a portion of the plurality of pseudorange measurements, wherein the aggregating comprises: creating a graph representative of relationships between pairs of pseudorange measurements of at least a subset of the plurality of pseudorange measurements, processing the at least a subset of the plurality of pseudorange measurements with a graph neural network (GNN), and pooling outputs of the GNN from the processing; and determining a location estimate of the GNSS device based at least in part on the aggregation of the residual information.

What is claimed is:

1. A method of positioning a global navigation satellite system (GNSS) device using residual grid representation, the method comprising:
determining an approximate location of the GNSS device;
for each pseudorange measurement of a plurality of pseudorange measurements performed by the GNSS device:
determining a location of a respective satellite vehicle (SV) that transmits a respective GNSS signal of which the pseudorange measurement is performed, the location of the respective SV relative to the approximate location of the GNSS device; and
determining a respective residual grid, wherein:
the respective residual grid is based at least in part on respective information from the pseudorange measurement and the location of the respective SV, and
the respective residual grid is indicative of possible locations of the GNSS device within a geographical region including the approximate location of the GNSS device;
aggregating the residual grids corresponding to at least a portion of the plurality of pseudorange measurements; and
determining a location estimate of the GNSS device based at least in part on the aggregation of the residual grids.

2. The method of claim 1, wherein determining the respective residual grid for each pseudorange measurement of the plurality of pseudorange measurements comprises, for each pseudorange measurement of a plurality of pseudorange measurements:
determining a respective initial residual grid based at least in part on the respective pseudorange measurement information, the approximate location of the GNSS device, and the location of the respective SV, and
determining the respective residual grid based at least in part on modifying the respective initial residual grid using error correction for the respective pseudorange measurement information.

3. The method of claim 2, wherein the error correction corrects for:
receiver clock bias,
ionospheric delay,
tropospheric delay,
constellation time bias,
rotation of the Earth, or
any combination thereof.

4. The method of claim 3, wherein, for at least one pseudorange measurement of the plurality of pseudorange measurements, the receiver clock bias, the constellation time bias, or both, is independently applied to a plurality of locations within the respective residual grid.

5. The method of claim 1, wherein aggregating the residual grids corresponding to at least a portion of the plurality of pseudorange measurements comprises:
processing each of the residual grids corresponding to the at least a portion of the pseudorange measurements with a respective convolutional neural network (CNN); and
combining outputs of the CNNs corresponding to the at least a portion of the pseudorange measurements.

6. The method of claim 5, further comprising, for each pseudorange measurement of the at least a portion of the plurality of pseudorange measurements, including one or more respective features of the respective GNSS signal on which the pseudorange measurement is performed, prior to combining the outputs of the CNNs.

7. The method of claim 1, wherein aggregating the residual grids comprises:
creating a graph representative of relationships between pairs of pseudorange measurements of at least a subset of the plurality of pseudorange measurements;
processing the at least a subset of the plurality of pseudorange measurements with a graph neural network (GNN); and
pooling outputs of the GNN from the processing.

8. The method of claim 7, wherein the relationships between pairs of pseudorange measurements are indicative of:
whether the pairs of pseudorange measurements correspond to the same SV,
whether the pseudorange measurements correspond to the same GNSS frequency band,
an angular distance between SVs corresponding to a pair of pseudorange measurements,
a difference between residuals of the pair of pseudorange measurements, or
any combination thereof.

9. The method of claim 8, wherein the relationships between pairs of pseudorange measurements are indicative of the angular distance between SVs corresponding to a pair of pseudorange measurements, and wherein:
the graph comprises a complete graph comprising relationships between all pairs of pairs of pseudorange measurements in the graph,
the graph comprises a sparse graph comprising relationships between pairs of pseudorange measurements in the graph for which the angular distance between SVs is less than a threshold angular distance, or
the graph comprises a k nearest neighbor (k-NN) graph of comprising relationships between pairs of pseudorange measurements in the graph for having the lowest angular distance between SVs up to a number k.

10. The method of claim 7, further comprising extracting a set of global features of the plurality of pseudorange measurements, wherein the GNN further processes the set of global features.

11. The method of claim 1, wherein determining the location estimate of the GNSS device based at least in part on the aggregation of the residual grids comprises:
(A) determining residual corrections based at least in part on the aggregation of the residual grids, and determining the location estimate by performing weighted least squares (WLS) using the residual corrections;
(B) processing the aggregation of the residual grids using a multi-layer perceptron (MLP); or
(C) processing the aggregation of the residual grids to determine a GNSS device position distribution, and determining the location estimate from the GNSS device position distribution.

12. A global navigation satellite system (GNSS) device comprising:
a GNSS receiver;
a memory; and
one or more processors communicatively coupled with the GNSS receiver and the memory, wherein the one or more processors are configured to:
determine an approximate location of the GNSS device;
for each pseudorange measurement of a plurality of pseudorange measurements performed by the GNSS device using the GNSS receiver:
determine a location of a respective satellite vehicle (SV) that transmits a respective GNSS signal of which the pseudorange measurement is performed, the location of the respective SV relative to the approximate location of the GNSS device; and
determine a respective residual grid, wherein:
the respective residual grid is based at least in part on respective information from the pseudorange measurement and the location of the respective SV, and
the respective residual grid is indicative of possible locations of the GNSS device within a geographical region including the approximate location of the GNSS device;
aggregate the residual grids corresponding to at least a portion of the plurality of pseudorange measurements; and
determine a location estimate of the GNSS device based at least in part on the aggregation of the residual grids.

13. The GNSS device of claim 12, wherein, to determine the respective residual grid for each pseudorange measurement of the plurality of pseudorange measurements, the one or more processors are configured to, for each pseudorange measurement of a plurality of pseudorange measurements:
determine a respective initial residual grid based at least in part on the respective pseudorange measurement information, the approximate location of the GNSS device, and the location of the respective SV, and
determine the respective residual grid based at least in part on modifying the respective initial residual grid using error correction for the respective pseudorange measurement information.

14. The GNSS device of claim 13, wherein the one or more processors are configured to use the error correction to correct for:
receiver clock bias,
ionospheric delay,
tropospheric delay,
constellation time bias,
rotation of the Earth, or
any combination thereof.

15. The GNSS device of claim 12, wherein, to aggregate the residual grids corresponding to at least a portion of the plurality of pseudorange measurements, the one or more processors are configured to:
process each of the residual grids corresponding to the at least a portion of the pseudorange measurements with a respective convolutional neural network (CNN); and
combine outputs of the CNNs corresponding to the at least a portion of the pseudorange measurements.

16. The GNSS device of claim 12, wherein, to aggregate the residual grids, the one or more processors are configured to:
create a graph representative of relationships between pairs of pseudorange measurements of at least a subset of the plurality of pseudorange measurements;
process the at least a subset of the plurality of pseudorange measurements with a graph neural network (GNN); and
pool outputs of the GNN from the processing.

17. The GNSS device of claim 16, wherein the one or more processors are configured to include an indication, in the relationships between pairs of pseudorange measurements, of:
whether the pairs of pseudorange measurements correspond to the same SV,
whether the pseudorange measurements correspond to the same GNSS frequency band,
an angular distance between SVs corresponding to a pair of pseudorange measurements,
a difference between residuals of the pair of pseudorange measurements, or
any combination thereof.

18. The GNSS device of claim 17, wherein the one or more processors are configured to include an indication, in the relationships between pairs of pseudorange measurements, of the angular distance between SVs corresponding to a pair of pseudorange measurements, and wherein the one or more processors are configured to create the graph such that the graph comprises:
a complete graph comprising relationships between all pairs of pairs of pseudorange measurements in the graph,
a sparse graph comprising relationships between pairs of pseudorange measurements in the graph for which the angular distance between SVs is less than a threshold angular distance, or
a k nearest neighbor (k-NN) graph of comprising relationships between pairs of pseudorange measurements in the graph for having the lowest angular distance between SVs up to a number k.

19. The GNSS device of claim 12, wherein, to determine the location estimate of the GNSS device based at least in part on the aggregation of the residual grids, the one or more processors are configured to:
(A) determine residual corrections based at least in part on the aggregation of the residual grids, and determine the location estimate by performing weighted least squares (WLS) using the residual corrections;
(B) process the aggregation of the residual grids using a multi-layer perceptron (MLP); or
(C) process the aggregation of the residual grids to determine a GNSS device position distribution, and determine the location estimate from the GNSS device position distribution.

20. An apparatus for positioning a global navigation satellite system (GNSS) device using residual grid representation, the apparatus comprising:
means for determining an approximate location of the GNSS device;
for each pseudorange measurement of a plurality of pseudorange measurements performed by the GNSS device:
means for determining a location of a respective satellite vehicle (SV) that transmits a respective GNSS signal of which the pseudorange measurement is performed, the location of the respective SV relative to the approximate location of the GNSS device; and
means for determining a respective residual grid, wherein:
the respective residual grid is based at least in part on respective information from the pseudorange measurement and the location of the respective SV, and
the respective residual grid is indicative of possible locations of the GNSS device within a geographical region including the approximate location of the GNSS device;
means for aggregating the residual grids corresponding to at least a portion of the plurality of pseudorange measurements; and
means for determining a location estimate of the GNSS device based at least in part on the aggregation of the residual grids.
